(19) United States
(12) Patent Application Publication
(10) Pub. No.: US 2006/0002414 A1
(43) Pub. Date: Jan. 5, 2006

(54) Statistical data rate allocation for MIMO systems

(76) Inventors: Jianxuan Du, Belmont, MA (US); Andreas F. Molisch, Arlington, MA (US); Jinyun Zhang, Cambridge, MA (US)

Correspondence Address: Patent Department;Mitsubishi Electric Research Laboratories, Inc., 201 Broadway, Cambridge, MA, 02139, US

(21) Appl. No.: 10/872,578

(22) Filed: Jun. 21, 2004

(51) Int. Cl. H04L 12/28; H04L 12/56

(52) U.S. Cl. 370/413

(57) ABSTRACT

A method allocates data rates to layers to be transmitted in a multiple input, multiple output communications system. An input data stream is demultiplexed into multiple layers. For each layer, determine statistics representing a capacity of the layer based on past observations of transmitting the layer through a channel. For each layer, determine an optimum data rate based on the statistics. For each layer, determine if the optimum data rate is less than a minimum data rate of a set of available bit rates, and, if true, selecting, for a particular layer, the minimum data rate from the set of available data rates, and otherwise, if false, selecting, for the particular layer, a closest data rate from the set of available data rates that is less than the optimum data rate.

### FIELD OF THE INVENTION

This invention relates generally to multiple-input, multiple-output communication systems, and more particularly to allocating data rates to layers in MIMO systems.

### BACKGROUND OF THE INVENTION

A general architecture for multiple-input, multiple-output (MIMO) communications systems is well known, E. Telatar, “Capacity of multi-antenna Gaussian channels,” European Tansactions on Telecommunications, vol. 10, pp. 585-595, November-December 1999, and G. J. Foschini and M. J. Gans, “On the limits of wireless communications in a fading environment when using multiple antennas,” Wireless Personal Commun., vol. 6, pp. 315-335, March 1998. However, it is still a problem to develop practical systems based on the MIMO architecture that approach a theoretical channel capacity.

MIMO systems can use closed-loop or open-loop architectures. In a closed-loop system, the transmitter uses feedback information from the receiver to determine data rates based on instantaneous channel conditions. This improves the system's capacity but increases the complexity, overhead and cost of the system. In an open-loop system, the transmitter does not require instantaneous feedback from the receiver to determine data rates. Therefore, it is preferred to use an open-loop architecture.

In space-time coded systems, one method uses bit interleaved coded modulation (BICM), B. M. Hochwald and S. ten Brink, “Achieving near-capacity on a multiple-antenna channel,” IEEE Trans. Wireless Commun., vol. 51, pp. 389-399, March 2003. BICM uses list sphere decoding and iterative channel decoding to approach the capacity of MIMO channels for low and medium data rate transmission with a moderate number of transmit antennas. However, for a large number of transmit antennas and high order modulation, the limited size of the list used in the sphere decoding severely degrades performance.

Another method for MIMO systems uses vertical Bell Laboratory layered space-time structure (V-BLAST), G. J. Foschini, “Layered space-time architecture for wireless communication in a fading environment when using multi-element antennas,” Bell Labs Technical Journal, pp. 41-59, August 1996, P. W. Wolniansky, G. J. Foschini, G. D. Golden, and R. A. Valenzuela, “V-BLAST: An architecture for realizing very high data rate over the rich-scattering wireless channel,” Proc. URSI Int. Symp. Signals, Systems, and Electronics, pp. 295-300, October 1998, and H. E. Gamal and J. A. R. Hammons, “A new approach to layered space-time coding and signal processing,” IEEE Trans. Inform. Theory, vol. 47, pp. 2321-2334, September 2001.

In V-BLAST, the input data stream is demultiplexed to multiple substreams or ‘layers’. Each layer is encoded independently using one-dimensional encoding, and each encoded layer is sent concurrently via a different antenna to receiver antennas.

To detect each layer in the receiver, a linear processing according to zero-forcing (ZF) or minimum mean square-error (MMSE) criteria can be used to null undetected layers in the received signal. The contribution of detected layers is subtracted by decision-directed successive interference cancellation (SIC).

In a V-BLAST system, the input data stream is typically divided evenly into the layers, and all layers have an identical data rate. As a result, the layers, which are detected first, are more prone to error due to a loss of signal energy by the nulling. Therefore, the prior art V-BLAST system does not approach the theoretical channel capacity, even with an optimal ordering of the detection.

Therefore, there is a need for an open-loop MIMO system that approaches the theoretical channel capacity for high data rates or for a large number of antennas.

### SUMMARY OF THE INVENTION

The invention provides a MIMO system that uses a layered structure with unequal rate allocation. Instead of allocating the data rates among the layers equally, or according to instantaneous data rate feedback in a closed loop system, the invention uses statistical information of the channel based on past observations to determine the data rate allocated to each layer.

It is an objective of the invention to allocate data rate according to quality of channels for the layers. Layers to be detected first have a lower data rates because those layers have a lower quality channel due to the nulling of undetected layers.

### BRIEF DESCRIPTION OF THE DRAWINGS

FIG. 1 is a block diagram of a transmitter for a layered MIMO system according to the invention;

FIG. 2 is a block diagram of a receiver for the layered MIMO system according to the invention; and

FIG. 3 is a flow diagram of a method for allocating data rates among layers according to the invention;

### DETAILED DESCRIPTION OF THE PREFERRED EMBODIMENT

Transmitter Structure

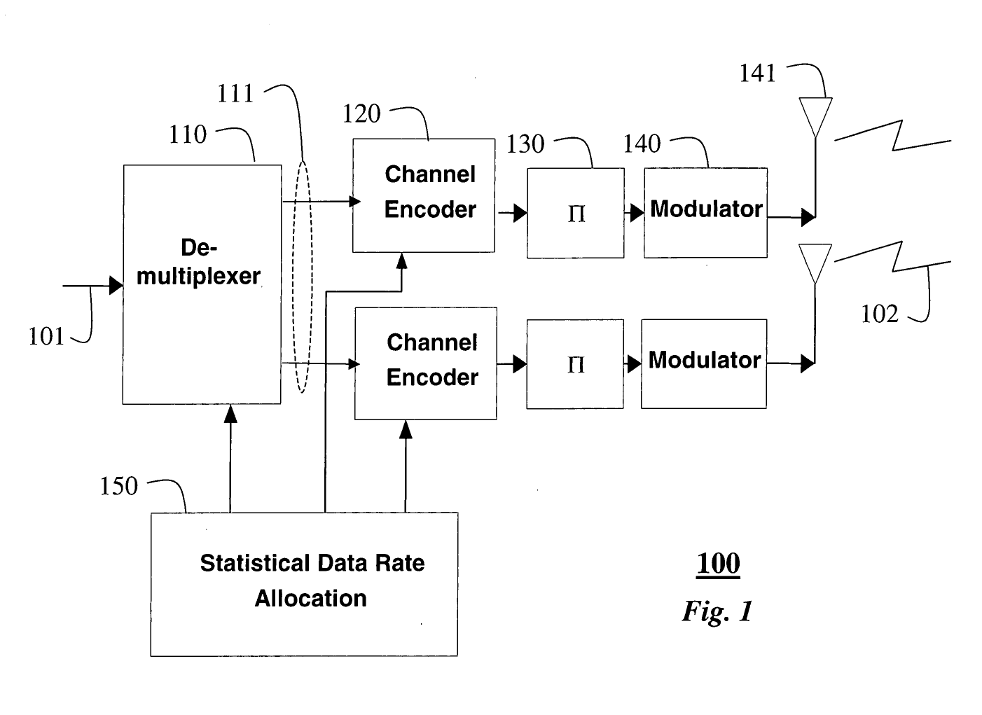

FIG. 1 shows a transmitter 100 for a layered MIMO system according to the invention. An input data stream 101 is demultiplexed 110 to Nₜ substreams or ‘layers’ 111. Each layer is encoded 120 independently. The encoded layers are interleaved (Π) 130 and modulated 140 and sent concurrently to different transmit antennas 141 to be transmitted as transmit signals 102 through a channel. In the example shown, Nₜ=2, although it should be understood that any practical number of transmit and receive antennas can be used with the invention.

The demultiplexing 110 and encoding 120, according to the invention, use a statistical rate allocation 150 as described herein. The statistics are based on past observations of the layer capacities, as opposed to instantaneous feedback.

Receiver Structure

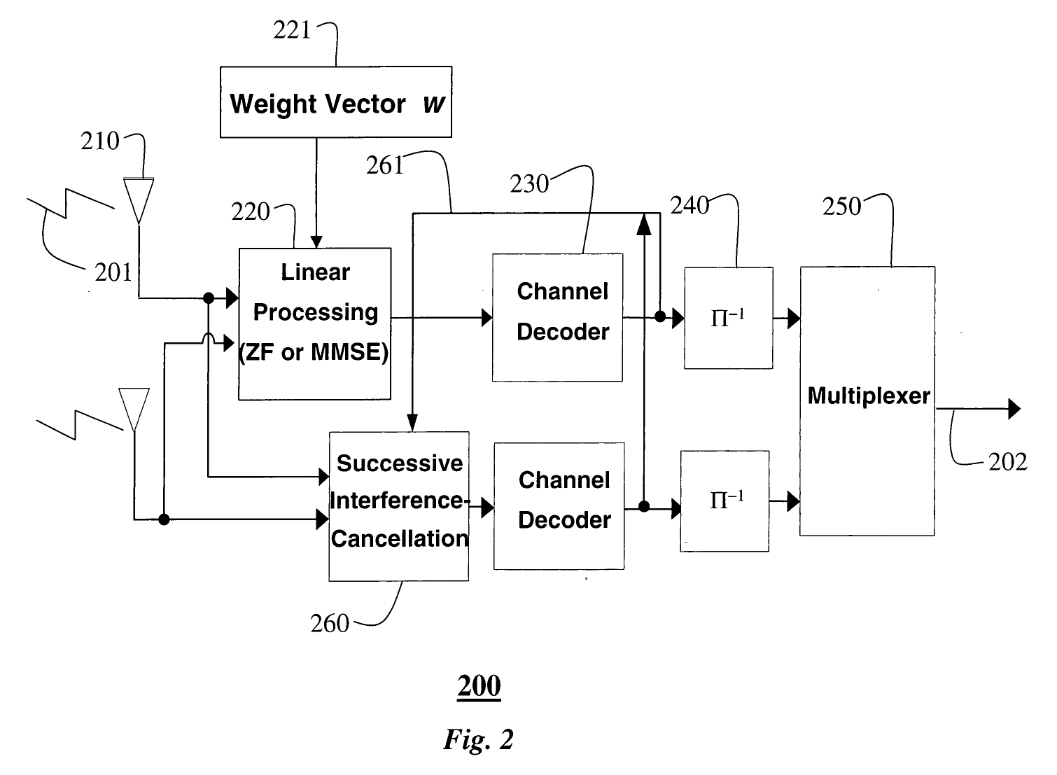

FIG. 2 shows a receiver 200 in the layered MIMO system according to the invention. Signals 201 are received by Nᵣ receive antennas 210. Linear processing 220 is applied to null undetected layers. The processed signals are decoded 230, and de-interleaved (Π⁻¹) 240 before sent to the multiplexer 250 where the decoded layers are combined into a reconstructed output signal 202 corresponding to the input signal 101. Successive interference-cancellation 260, in the receiver, is according to decision feedback information 261.

System Model

In a flat-fading MIMO system with Nₜ transmit antennas and Nᵣ receive antennas, a relationship between transmitted signals 102 and received signals 201 can be expressed as
r=Hs+n,
where r is a Nᵣ×1 vector representing the received signals 201, s is a Nₜ×1 vector representing the transmitted signals 102, and H is a Nᵣ×Nₜ channel matrix representing an impulse response of the channel. A Nᵣ×1 noise vector n has entries that are independent and identically distributed (i.i.d.) zero-mean circular complex Gaussian random variables with a variance N₀.

An open-loop channel capacity is given by

$$C ( H , SNR ) = {log}_{2} det ( {I}_{{N}_{r}} + \frac{SNR}{{N}_{t}} {HH}^{H} ) ,$$

where I_{N}_{ᵣ} is a Nᵣ×Nᵣ identity matrix, and SNR is the signal-to-noise ratio.

Without loss of generality, we assume that each layer l 111 is sent via transmit antenna l 141, and the order of detection is from 1 to Nₜ. Then, at the receiver 200, layer i is decoded 230, based on zᵢ determined as follows,

$${z}_{i} = {w}_{i}^{H} ( r - {\sum }_{l = 1}^{i - 1} {h}_{l} {\hat{s}}_{l} ) ,$$

where the Nᵣ×1 unit-norm weight vector wᵢ 221 nulls 220 signals from all other undecoded layers. The weight vector 221 is determined according to zero-forcing or MMSE criterion. The reconstructed signals 261 from decoded layers are ŝₗ. The value hₗ is the l^{th} column of the channel matrix H.

After the linear processing 220 and the interference cancellation 260, layer i is decoded 230 using a one-dimensional code.

Data Rate Allocation for Layered Systems

In the MIMO system, the optimal data rate to be allocated to layer l should be

$${C}_{l} = {log}_{2} det ( {I}_{{N}_{r}} + \frac{SNR}{{N}_{t}} {H}_{( l - 1 )} {H}_{( l - 1 )}^{H} ) - {log}_{2} det ( {I}_{{N}_{r}} + \frac{SNR}{{N}_{t}} {H}_{( l )} {H}_{( l )}^{H} ) , \qquad ( 1 )$$

where H₍ₗ₎=[hₗ₊₁ hₗ₊₂ . . . h_{N}_{ₜ}], and hₗ is the l^{th} column of the channel matrix H.

The capacity of a MIMO channel such as the first and the second term in the equation (1), whether Rayleigh or Ricean, can be approximated accurately by a Gaussian distribution, at medium and high SNRs, P. J. Smith and M. Shafi, “On a Gaussian approximation to the capacity of wireless MIMO systems,” Proc. ICC 2002, pp. 406-410, April 2002, M. A. Kamath, B. L. Hughes, and X. Yu, “Gaussian approximations for the capacity of MIMO Rayleigh fading channels,” IEEE Asilomar Conference on Signals, Systems, and Computers, November 2002.

Thus, the capacity of each layer Cₗ is also Gaussian distributed, and can be denoted by
Cₗ˜N(ηₗ,σₗ²),
where ηₗ, and σₗ² are the mean and variance of the capacity of layer l, respectively. The important point here is that the capacity is expressed statistically, instead of being based on actual capacity derived from instantaneous feedback information. It should also be noted that other statistics, such as a Gamma distribution and higher order statistics, can be used express the capacity of the channel.

In our MIMO system, instead of dynamically changing the data rate for each layer, we fix layer l to a data rate uₗ, which is based on the means and variances of all the layer capacities, i.e., first and second order statistics. Minimizing a probability of not achieving a required performance, i.e., the outage probability Pₒᵤₜ, of a layered system is equivalent to maximizing a probability

$$1 - {P}_{out} = {\prod }_{l = 1}^{M} {\int }_{{u}_{l}}^{∞} \frac{1}{\sqrt{2 π} {σ}_{l}} {ⅇ}^{- \frac{{( t - {η}_{l} )}^{2}}{2 {σ}_{l}^{2}}} ⅆ t ,$$

when no layer has a data rate greater than the respective capacity of the layer, and subject to the constraint that a total data rate C_{T} of the channel is fixed, i.e.,

$${\sum }_{l = 1}^{M} {u}_{l} = {C}_{T} .$$

Let the data rate of a layer be a difference xₗ=uₗ−ρₗ. By setting up an equivalent Lagrangean objective function, we find a stationary point, that is, a point where a derivative of the function vanishes, from the objective function

$$J = log ( {\prod }_{l = 1}^{M} {\int }_{{x}_{l}}^{∞} \frac{1}{\sqrt{2 π} {σ}_{l}} {ⅇ}^{- \frac{{t}^{2}}{2 {σ}_{l}^{2}}} ⅆ t ) - λ ( {\sum }_{l = 1}^{M} {x}_{l} + {\sum }_{l = 1}^{M} {η}_{l} - {C}_{T} ) .$$

We can verify that the stationary point satisfies

$$- \frac{{ⅇ}^{\frac{{x}_{l}^{2}}{2 {σ}_{l}^{2}}}}{{\int }_{{x}_{l}}^{∞} \frac{1}{\sqrt{2 π} {σ}_{l}} {ⅇ}^{- \frac{{t}^{2}}{2 {σ}_{l}^{2}}} ⅆ t} = λ , l = 1 , 2 , … , M . \\ because$$

$${\int }_{{x}_{l}}^{∞} \frac{1}{\sqrt{2 π} {σ}_{l}} {ⅇ}^{- \frac{{t}^{2}}{2 {σ}_{l}^{2}}} ⅆ t \approx 1 , {x}_{l} / {σ}_{l} ⪡ 0.$$

Therefore, the difference between the optimum data rate and the mean of the capacity of a layer is

$${x}_{l}^{*} \approx \frac{{σ}_{l}}{{\sum }_{m = 1}^{M} {σ}_{m}} ( {C}_{T} - {\sum }_{m = 1}^{M} {η}_{m} ) ,$$

and an optimum data rate u* for the layer l is

$${u}_{l}^{*} \approx {η}_{l} + \frac{{σ}_{l}}{{\sum }_{m = 1}^{M} {σ}_{m}} ( {C}_{T} - {\sum }_{m = 1}^{M} {η}_{m} ) . \qquad ( 2 )$$

Therefore, the outage probability for each layer is

$${P}_{l}^{*} = {\int }_{- ∞}^{{x}_{l}^{*}} \frac{1}{\sqrt{2 π} {σ}_{l}} {ⅇ}^{- \frac{{t}^{2}}{2 {σ}_{l}^{2}}} ⅆ t = {\int }_{- ∞}^{\frac{( {C}_{T} - {\sum }_{m = 1}^{M} {η}_{m} )}{{\sum }_{m = 1}^{M} {σ}_{m}}} \frac{1}{\sqrt{2 π}} {ⅇ}^{- \frac{{t}^{2}}{2}} ⅆ t ,$$

which is the same for all layers. Thus, a minimum total outage probability is achieved when the outage probability of each layer is identical.

We define a normalized capacity margin as

$$φ {=}^{Δ} \frac{( {\sum }_{m = 1}^{M} {η}_{m} - {C}_{T} )}{{\sum }_{m = 1}^{M} {σ}_{m}} . \qquad ( 3 )$$

Then, an optimum total outage probability is

$${P}_{out}^{*} = 1 - {\prod }_{l = 1}^{M} ( 1 - {P}_{l}^{*} ) = 1 - {( {\int }_{φ}^{o} \frac{1}{\sqrt{2 π}} {ⅇ}^{- \frac{{t}^{2}}{2}} ⅆ t )}^{M} ,$$

which states an interesting fact. The minimum total outage probability of a layered system is uniquely determined by the normalized capacity margin.

That is, if we properly select the data rate for each layer, the sum of capacities of all layers, with perfect SIC, is exactly the same as that obtained by instantaneous feedback. To achieve that capacity, instantaneous data rate feedback is needed. However, if the channel is ergodic enough, such as those with enough frequency selectivity or time variation, we can approach that capacity by statistically determining the data rate for each layer, with a small penalty. Our approach is to minimize the overall outage probability given the total data rate. Because of the results above, we use a statistical approach for allocating bits to different layers.

We use an asymptotic expansion according to M. A. Kamath, B. L. Hughes, and X. Yu, “Gaussian approximations for the capacity of MIMO Rayleigh fading channels,” IEEE Asilomar Conference on Signals, Systems, and Computers, November 2002, which is

$${\int }_{φ}^{o} \frac{1}{\sqrt{2 π}} {ⅇ}^{- \frac{{t}^{2}}{2}} ⅆ t \approx \sqrt{2 π} - \frac{{ⅇ}^{\frac{{x}^{2}}{2}}}{x} ( 1 - \frac{1}{{x}^{2}} + \frac{1 \cdot 3}{{( {x}^{2} )}^{2}} … ) , x \text{<<} 0 , \\ then {P}_{out}^{*} \approx \frac{M}{\sqrt{2 πφ}} {ⅇ}^{- {φ}^{2} / 2} .$$

Similarly, we derive an asymptotic outage probability of the MIMO channel with the total overall data rate C_{T} as

$${P}_{ch} \approx \frac{1}{\sqrt{2 {πφ}_{ch}}} {ⅇ}^{- {ϕ}_{ch}^{2} / 2} , where {φ}_{ch} = \frac{{η}_{ch} - {C}_{T}}{{σ}_{ch}} ,$$

where η_{ch} is an ergodic MIMO channel capacity, i.e., every sequence or sizable sample is equally representative of the whole as in regard to a statistical parameter, and σ_{ch}² is the variance of the MIMO channel capacity. Note that

$${η}_{ch} = {\sum }_{l = 1}^{M} {η}_{l} , and {σ}_{ch} \leq {\sum }_{l = 1}^{M} {σ}_{l} , because$$

$$E \{ {( {\sum }_{l} {v}_{l} )}^{2} \} \leq {( {\sum }_{l} \sqrt{E \{ {v}_{l}^{2} \}} )}^{2} ,$$

for any set of random variables {vₗ′s}.

Thus,

$${φ}_{ch} \leq φ , and$$

$${P}_{out} \geq {P}_{out}^{*} \approx \frac{M}{\sqrt{2 πφ}} {ⅇ}^{- {φ}^{2} / 2} \geq M \frac{1}{\sqrt{2 {πφ}_{ch}}} {ⅇ}^{- {φ}_{ch}^{2} / 2} \approx {MP}_{ch} ,$$

which implies that with the identical data rates, the asymptotic outage probability of the layered structure is at least M times that of the MIMO channel.

Because of the above results, we provide a statistical method for determining the data rate allocation, subject to the following constraints.

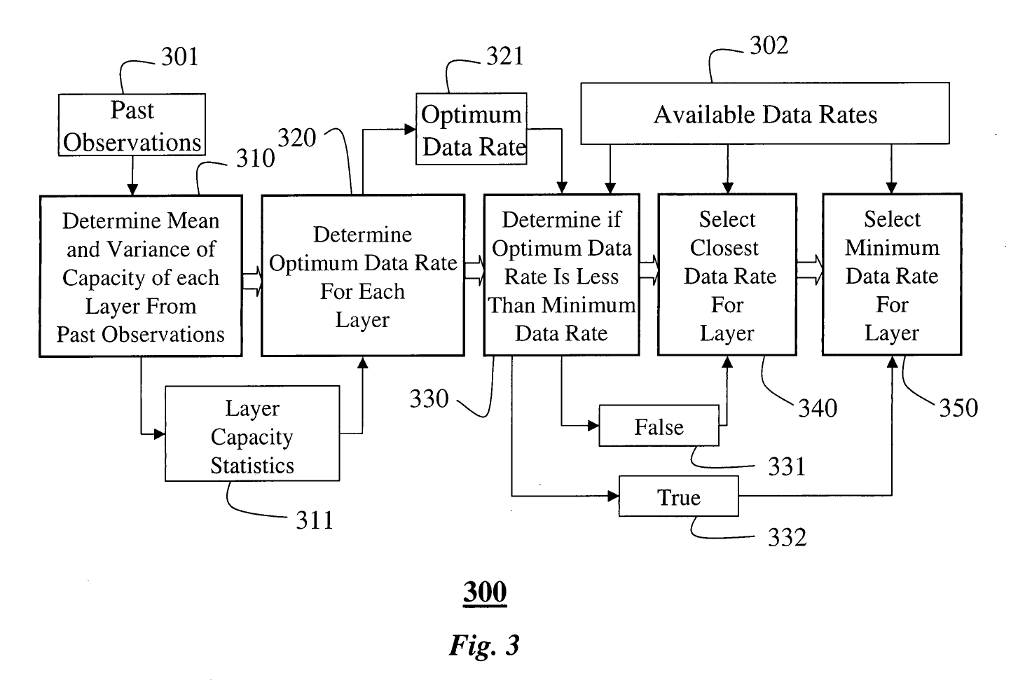

In practical communication systems, there are only a limited number of combinations of modulation and coding rate. Therefore, a set of N available data rates c₁<c₂< . . . <c_{N} 302 is discrete, see FIG. 3. Here, the data rates are arranged in a low to high order, where c₁ is a minimum available data rate and c_{N} is a maximum available data rate of the set.

Any Gaussian distribution has a negative tail, therefore, our analysis above applies primarily to systems with a high SNR, where an optimum data rate uₗ* of each layer is guaranteed to be positive.

Statistical Data Rate Allocation Method

FIG. 3 shows our method 300 for allocating data rates among multiple layer in a MIMO communications system.

First, we determine 310 statistics 311, e.g., a mean TI, and a variance σₗ² of a capacity of each layer based on past observations 301 of capacities of layers as the layers were transmitted through a channel, as given by Equation (1). The means and variances can be determined entirely in the transmitter, based on signals sent from the receiver as acknowledgement to transmitted messages. It should be noted that other statistics can be used.

It should be made clear, that the statistics do not need to be based on instantaneous actual channel condition, but rather the statistics can be based only on historical data.

In the beginning of transmission, where no historical data are available, empirically derived statistics can be used to set the initial data rates for the layers. The empirical data can be obtained from experiments or simulation using standard channel models.

For a total data rate C_{T}, determine 320, for each layer, an optimum data rate uₗ* 321 according to Equation (2), based on the layer capacity statistics 311 of each layer.

Determine 330 if the optimum data rate uₗ* is less than a minimum data rate of a set of available data rates 302.

If false 331, then select 340 a closest data rate cₗ* of the available data rates 302 that is less than the optimum data rate uₗ*.

Otherwise, if true 332, then select 350 the data rate c; to be a minimum of the set of available data rates.

Note in the system described, we may use different modulations for different layers depending on the chosen data rates.

Variations

The approach proposed above can also be applied to the cases where the association of transmit antennas with layers varies, or is frequency-selective such as in OFDM systems. We only have to sum up all the data rates as given by Equation (1) for each layer and determine the corresponding mean and variance of the channel capacity for each layer.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for allocating data rates to layers to be transmitted in a multiple input, multiple output communications system, comprising:
demultiplexing an input data stream into multiple layers;
determining, for each layer, statistics representing a capacity of the layer based on past observations of transmitting the layer through a channel;
determining, for each layer, an optimum data rate based on the statistics;
determining, for each layer, if the optimum data rate is less than a minimum data rate of a set of available bit rates;
if true, selecting, for a particular layer, the minimum data rate from the set of available data rates; and otherwise
if false, selecting, for the particular layer, a closest data rate from the set of available data rates that is less than the optimum data rate.

2. The method of claim 1, in which a relationship between transmitted signals and received signals is expressed by r=Hs+n, where r is a Nᵣ×1 vector representing the received signals, s is a Nᵣ×1 vector representing the transmitted signals, and H is a Nᵣ×N. channel matrix representing an impulse response of the channel, and n is a Nᵣ×1 noise vector with entries that are independent and identically distributed, zero-mean circular complex Gaussian random variables with a variance N₀, and an open-loop capacity of the channel is
$$C ( H , SNR ) = {log}_{2} det ( {I}_{{N}_{r}} + \frac{SNR}{{N}_{t}} {HH}^{H} ) ,$$
where I_{N}_{ᵣ} is a Nᵣ×Nᵣ identity matrix, and SNR is a signal-to-noise ratio.

3. The method of claim 2, in which a desired data rate to be allocated to each layer l is
$${C}_{l} = {log}_{2} det ( {I}_{{N}_{r}} + \frac{SNR}{{N}_{t}} {H}_{( l - 1 )} {{H}_{( l - 1 )}}^{H} ) - \\ {log}_{2} det ( {I}_{{N}_{r}} + \frac{SNR}{{N}_{t}} {H}_{( l )} {{H}_{( l )}}^{H} ) ,$$
where H₍ₗ₎=[hₗ₊₁ hₗ₊₂ . . . h_{N}_{ₜ}], and hₗ is an l^{th} column of the channel matrix H.

4. The method of claim 3, in which the capacity of each layer, based on the past observations is Cₗ˜N(ρₗ,σₗ²), where ρₗ and σₗ² are the mean and variance of the capacity of layer l, respectively.

5. The method of claim 1, in which the statistics are first and second order statistics.

6. The method of claim 1, in which an overall outage probability is minimized for a total data rate for all the layers.

7. The method of claim 1, in which the statistics are a mean and a variance of the capacity of each layer.

8. The method of claim 1, in which the statistics are determined in a transmitter of the layers.

9. The method of claim 1, in which the statistics are determined in a receiver of the layers.

10. The method of claim 1, in which an association of transmit antennas with the layers varies.

11. The method of claim 1, in which the system is frequency-selective.

12. The method of claim 1, in which the statistics are modeled by a Gaussian distribution.
